(19) United States
(12) Patent Application Publication
(10) Pub. No.: US 2010/0008201 A1
(43) Pub. Date: Jan. 14, 2010

(54) DEMODULATION METHOD AND APPARATUS

(75) Inventors: Michikazu Hashimoto, Saitama (JP); Kiyoshi Tateishi, Saitama (JP)

Correspondence Address: DRINKER BIDDLE & REATH (DC), 1500 K STREET, N.W., SUITE 1100, WASHINGTON, DC, 20005-1209, US

(73) Assignee: PIONEER CORPORATION, Tokyo (JP)

(21) Appl. No.: 12/513,966

(22) PCT Filed: Mar. 20, 2007
(86) PCT No.: PCT/JP2007/055689

§ 371 Date: May 7, 2009

(51) Int. Cl. G11B 20/10

(52) U.S. Cl. 369/59.22; G9B/20.009

(57) ABSTRACT

A demodulation method comprises the steps of performing branch metric computation on each of columns of a modulation symbol; calculating column path metrics that are respective path metrics of column state values of modulation symbols; and calculating symbol path metrics that are respective path metrics of symbol state values of the modulation symbols.

### TECHNICAL FIELD

The present invention relates to a method and apparatus for demodulating optical record data and particularly to a method and apparatus for demodulating data optically recorded as two-dimensional information in a recording medium.

### BACKGROUND ART

Hologram memory systems as memory systems are known which optically record and reproduce information into and from a hologram recording medium made of photopolymer or the like.

In the hologram memory system, when recording data into a hologram recording medium (hereinafter simply called a recording medium), input data is modulated (encoded) and divided into units called data pages that each are two-dimensional data, which are displayed on a spatial light modulator having a plurality of modulating pixels two-dimensionally arranged, thereby spatially modulating light to generate a signal light. Having the signal light and reference light interfere in the recording medium, the interference fringes are recorded in the recording medium.

Meanwhile, when reproducing two-dimensional data from the recording medium, only the reference light under the same conditions as when recording is irradiated onto a data-recorded portion of the recording medium, thereby producing reproduced light (diffracted light) and receiving a reproduced image formed by the reproduced light with an image sensor to reproduce an original data page.

Since a reproduced signal from the hologram memory is a two-dimensional signal and the waveform interference is also two-dimensional, there has been proposed decision feedback Viterbi decoding to which a so-called two-dimensional decision feedback method is applied (refer to, e.g., the following Patent Document 1).

Here, the decision feedback Viterbi decoding is decoding in where when performing usual Viterbi decoding in a row direction, the current row is Viterbi decoded using results of decoding the row preceding (above or below) the current row being decoded.

Because Viterbi decoding is performed using longitudinal information, there is the advantage that the error rate is reduced as compared with usual Viterbi decoding, thus enabling accurate reproduction. Further, there is also the advantage that the Viterbi decoding having the decision feedback method applied can reduce the number of states in Viterbi decoding as compared with Viterbi decoding not having the decision feedback method applied.

Since a record signal of the hologram memory is two-dimensionally modulated, if Viterbi detection is performed on a per pixel (bit) basis, the problem occurs that the detection results may become not compliant with a modulation rule, resulting in an increase in the error rate. For a one-dimensional signal, Viterbi detection can be made to comply with the modulation rule by limiting states or state transition in the Viterbi decoding as described in the following Patent Document 2. However, because the signal from the hologram memory is two-dimensional, states or state transition in an up/down direction (decision feedback direction) cannot be limited.

Therefore, if Viterbi detection is performed on a per pixel (bit) basis, the scale of the metric computation circuit can be reduced, but because Viterbi detection is performed irrespective of the modulation rule, the detection result may be a pattern not covered by the modulation rule, thus causing the problem of an increase in the number of errors (or the error rate).

[Patent Document 1] Japanese Patent Application Laid-Open Publication No. H11-317084 (p. 7, FIG. 2)

[Patent Document 2] Japanese Patent Application Laid-Open Publication No. 2002-208219 (p. 5, FIG. 4).

### DISCLOSURE OF THE INVENTION

### Problem to be Solved by the Invention

The invention was made in view of the above-mentioned points, and an object of the invention is to provide a demodulation method and apparatus that can reduce the amount of metric computation (or the circuit scale) and in addition achieve a good error rate characteristics.

### Means for Solving the Problem

According to the present invention, there is provided a demodulation method which reads modulation symbols sequentially from a recording medium in which a data page that is a group of a plurality of data symbols modulated according to a predetermined modulation rule and each having M rows and N columns (M≧1, N≧3) is recorded and reproduces the data page by maximum likelihood decoding which performs sequential metric computation on each of the modulation symbols. The method comprises the steps of performing branch metric computation on each of columns of the modulation symbol; calculating column path metrics that are respective path metrics of column state values of the modulation symbols; and calculating symbol path metrics that are respective path metrics of symbol state values of the modulation symbols.

Moreover, according to the present invention, there is provided a demodulation apparatus which reads modulation symbols sequentially from a recording medium in which a data page that is a group of a plurality of data symbols modulated according to a predetermined modulation rule and each having M rows and N columns (M≧1, N≧3) is recorded and reproduces the data page by maximum likelihood decoding which performs sequential metric computation on each of the modulation symbols. The apparatus comprises a branch metric computing unit for performing branch metric computation on each of columns of the modulation symbol; a column path metric computing unit for calculating column path metrics that are respective path metrics of column state values of the modulation symbols; and a symbol path metric computing unit for calculating symbol path metrics that are respective path metrics of symbol state values of the modulation symbols.

### BRIEF DESCRIPTION OF DRAWINGS

FIG. 1 is a block diagram showing an example of a hologram apparatus for recording and/or reproducing information as a hologram memory system;

FIG. 2 shows 6:9 modulation symbols for 6-bit input data and the column state value of each column of each modulation symbol;

FIG. 3 shows symbol state values (k) and state values of columns 1 to 3 according to a modulation rule for the 6:9 modulation symbols;

FIG. 4 shows schematically a bright/dark dot pattern of a spatial light modulator SLM displaying a data page;

FIG. 5 shows schematically pixel deviation that occurs between pixels of a reproduced signal and pixels of a two-dimensional sensor;

FIG. 6 shows a flow chart of the process of reproducing a data page in a demodulation apparatus using decision feedback Viterbi detection;

FIG. 7 shows a trellis diagram for when Viterbi detection is performed on each of the columns of the modulation symbol;

FIG. 8 shows five SPMs (symbol state value k=0, 4, 5, 24, 32) as examples of the symbol path metric (SPM);

FIG. 9 is a block diagram showing the configuration of a decoding circuit used in decoding the reproduced signal from a hologram memory;

FIG. 10 is a block diagram showing an example of the internal configuration of a metric computing unit;

FIG. 11 shows a relationship between the reproduced signal P and a reference signal series rmn;

FIG. 12 is a flow chart showing the procedure of Viterbi detection when decoding the reproduced signal;

FIG. 13 is a circuit diagram showing schematically an example of the specific circuit configuration of a CPM calculating unit;

FIG. 14 is a circuit diagram showing schematically an example of the specific circuit configuration of an SPM calculating unit;

FIG. 15 shows a bit error rate (BER) characteristic in a case where the Viterbi detection according to the present embodiment was performed for decoding in comparison with a bit error rate characteristic in a case of performing Viterbi detection on a per pixel (bit) basis; and

FIG. 16 shows the computation amount (number of computation times) in a case where the decoding according to the present embodiment was performed in comparison with that of a case of performing Viterbi detection on a per modulation symbol basis.

### EXPLANATION OF REFERENCE NUMERALS

SLM Spatial light modulator
10 Recording medium
20 Image sensor
23 Controller
25 Encoder
26 Decoder
31 Viterbi detector
32 Metric computing unit
33 Path memory
34 Demodulating circuit
35 Decoding controller
40A CPM calculating unit
40B SPM calculating unit
41 Branch metric calculator
43 First minimum determiner
47 SPM register unit
49 Second minimum determiner

### DETAILED DESCRIPTION OF THE INVENTION

Embodiments of the present invention will be described below with reference to the drawings.

### <Hologram Apparatus>

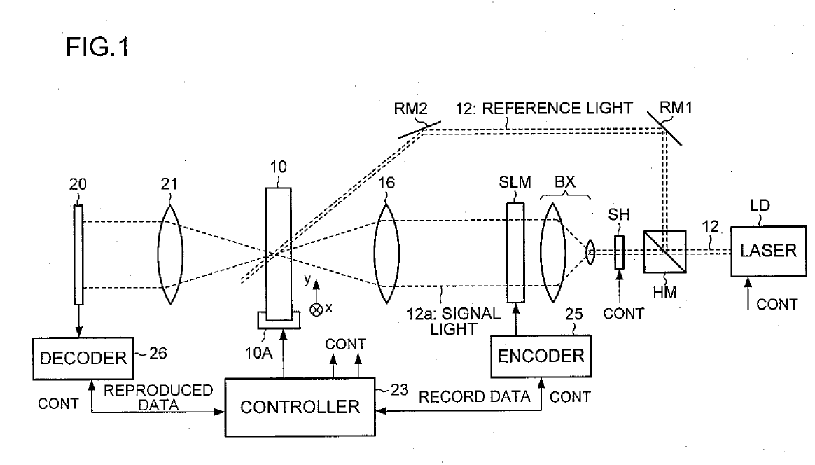

FIG. 1 shows an example of a hologram apparatus for recording and/or reproducing information as a hologram memory system.

In the optical path of coherent laser light 12 emitted from a laser source LD, there are arranged a half mirror HM, a shutter SH, a beam expander BX, a transmission spatial light modulator SLM, an object lens 16, a recording medium 10 made of photopolymer or the like, a second lens 21, and an image sensor 20.

The half mirror HM divides the laser light 12 to generate reference light and the other, and together with reflecting mirrors RM1, RM2 functions as a reference light optical system.

The shutter SH is controlled by a control signal CONT from a controller 23 to control time of the irradiation of a light beam onto the recording medium 10.

The beam expander BX expands light having passed through the shutter SH in diameter and collimates the light to be irradiated onto the spatial light modulator SLM.

The spatial light modulator SLM is a panel of a transmission liquid crystal display (LCD) having a plurality of modulating pixels arranged two-dimensionally in a matrix. The spatial light modulator SLM has, for example, 480 rows by 640 columns of pixels and displays a data page from an encoder 25 to optically modulate the irradiated light into a spatial on/off (bright/dark) signal, which is directed as signal light 12a to the object lens 16. The encoder 25 is controlled by a control signal CONT from the controller 23.

When the shutter SH is open (when recording), the object lens 16, Fourier transforming it, converges the signal light 12a to be focused behind the mounting position of the recording medium 10. The recording medium 10 is mounted on a support portion 10A.

The reflecting mirrors RM2 of the reference light optical system irradiates the reference light 12 onto the recording medium 10 at a predetermined incident angle. The action of the reflecting mirrors RM2 causes the reference light 12 to intersect at a predetermined angle with the signal light 12a in the recording medium 10.

The intersecting signal light and reference light interfere with each other inside the recording medium 10. The interference fringes are recorded as a refractive index grating in the recording medium 10, and thereby the data page is recorded. By changing the intersection angle of the reference light relative to the signal light, a plurality of data pages can be recorded in an angle-multiplexing manner.

The image sensor 20 is constituted by an array of a plurality of light receiving elements arranged two-dimensionally that correspond to the spatial light modulator pixels, such as CCDs (charge-coupled devices) or complementary metal-oxide semiconductor devices. Further, the image sensor 20 is connected to a decoder 26. The decoder 26 is connected to the controller 23. The light receiving elements of the image sensor 20 need not correspond to the spatial light modulator pixels on a one-to-one basis, but the sensor 20 need only have an arrangement of an enough number of light receiving elements to distinguish each pixel of an image of a data page displayed on the spatial light modulator.

When reproducing a recorded data page from the recording medium 10, with the signal light being blocked by the shutter SH, only the reference light is made incident at the same intersection angle as when recording. Reproduced light (diffracted light) corresponding to the recorded signal light appears on the opposite side of the recording medium 10 from the incidence side, on which the reference light is irradiated. This reproduced light is led to the image sensor 20 through the second lens 21. The image sensor 20 receives a reproduced image formed by the reproduced light and converts it into an electrical reproduced image signal again, which is then sent via the decoder 26 to the controller 23, which reproduces original input data.

### <Modulation (Encoding)>

In the hologram apparatus, when recording, a:b modulation (encoding) is performed for hologram-recording modulation (encoding). The a:b modulation will be described generally and briefly below.

In the a:b modulation, “a” denotes the number of bits of input data, and “b” denotes the number of bits of modulated data. In the modulated data, t bits of the b bits are at 1, and the other bits, (b-t) bits, are at 0, where t is a constant that satisfies combination _{b}Cₜ≧2^{a}.

The a:b modulation method will be described below taking 6:9 modulation (a=6, b=9) as an example. (The description below presents an example of the 6:9 modulation. The 6:9 modulation need only satisfy the above condition, and the description below is such an example.)

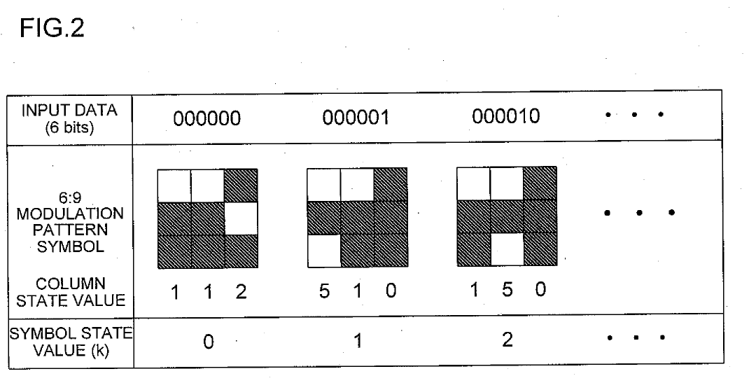

FIG. 2 shows two-dimensional modulation (6:9 modulation) pattern symbols (hereinafter called two-dimensional modulation symbols, or simply modulation symbols) for 6-bit input data “000000”, “000001”, “000010”, . . . and the column state value of each column of each modulation symbol.

As shown in FIG. 2, the two-dimensional modulation symbol of the 6:9 modulation consists of nine pixels (bits) in three rows and three columns. In the 6:9 modulation, there are ₉C₃=84 of combinations (patterns) when t=3. But leaving out the patterns where three pixels (bits) in line in a column direction, a row direction, or a diagonal direction are all “bright (1)”, that is, the patterns where “bright (1)” pixels are arranged consecutively (in a number of three) in line in a column direction, a row direction, or a diagonal direction, a total of 64 modulation symbols are selected. In other words, the two-dimensional modulation using the 6:9 modulation is to convert 6-bit input data into one of 64 (=26) patterns of modulation symbols.

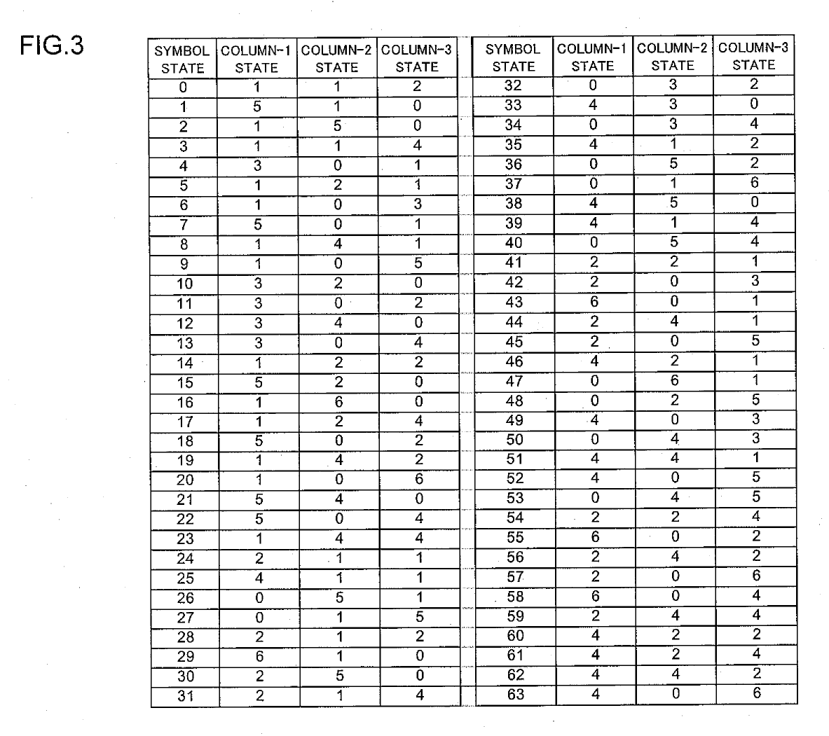

FIG. 3 shows all combinations as the 6:9 modulation symbols, that is, symbol state values (k) and state values of columns 1 to 3 according to the modulation rule of the 6:9 modulation symbols. The symbol state value (k) of FIG. 3 designates a modulation symbol pattern by number and corresponds to 6-bit input data. In this case, the symbol state value k ranges from 0 to 63. The state values of the columns 1 to 3 of each modulation symbol denote respectively the states of the columns of the 6:9 modulation pattern in three rows and three columns by octal number.

In this 6:9 modulation example, because the patterns where the first to third row pixels of a column are all at 1 are left out as mentioned above, the state values of columns 1 to 3 (column-1 state to column-3 state) each take on a value of 0 to 6.

The symbol state and the column-1 state to column-3 state of the 6:9 modulation symbols shown in FIG. 3 will be described in more detail. As shown in FIGS. 2 and 3, the first to third row pixels of the first column of the 6:9 modulation symbol (3 rows and 3 columns) corresponding to input data “000000” are “bright (1)”, “dark (0)”, and “dark (0)” respectively. Let these values be the first, second, and third binary digits (place values of 2⁰, 2¹, and 2² respectively), then the first column state is expresses as “001” in binary representation, and the column state value of the first column is “1”. Likewise, the column state value of the second column is also “1” (“001”). The first to third row pixels of the third column are “dark (0)”, “bright (1)”, and “dark (0)” respectively, and the column state value of the third column is “2” (“010”).

The symbol state value k of the pattern symbol corresponding to the input data “000000” is defined to be 0.

Likewise, the first to third row pixels of the first column of the modulation symbol corresponding to input data “000001” are “bright (1)”, “dark (0)”, and “bright (1)” respectively, and the column state value of the first column is “5” (“101”). Likewise, the column state value of the second column is “1” (“001”), and the column state value of the third column is “0” (“000”). The symbol state value of the modulation symbol corresponding to the input data “000001” is at 1.

Likewise, the column state value of the first column of the modulation symbol corresponding to input data “000010” is “1” (“001”); the column state value of the second column is “5” (“101”); and the column state value of the third column is “0” (“000”). The symbol state value of the modulation symbol corresponding to the input data “000010” is at 2.

As such, 64 modulation symbols (symbol state value k=0 to 63) correspond to the 6-bit input data. For each of the modulation symbols, the column states (column state values) of the first to third columns are defined (FIG. 3), and the column state values of the first to third columns denote the first to third columns of the 6:9 modulation symbol by state values of 0 to 6, respectively.

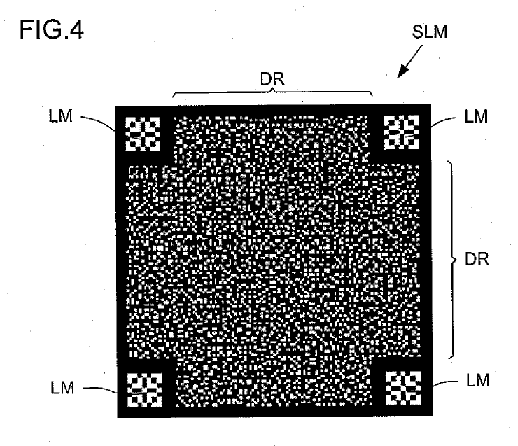

FIG. 4 shows schematically the spatial light modulator SLM displaying a data page. More specifically, the spatial light modulator SLM performs spatial light modulation on data (a group of two-dimensional modulation symbols). The bright/dark dot pattern of the spatial light modulator SLM is controlled by applying a voltage of on (bright)/off (dark) to each cell, the on/off corresponding to transmissive/non-transmissive in the pattern. The transmissive spatial light modulator. SLM is constituted by a liquid crystal panel with an analyzer having a plurality of pixel electrodes arranged in a matrix, or the like and is electrically controlled by the controller 23 via the encoder 25.

Where bit-series data is recorded by the 6:9 modulation, on the spatial light modulator SLM, two-dimensional modulation symbols are arranged, for example, in such a way as to advance from top left to the right and when reaching the right edge, go back to the left edge and go a step (three pixels) down to advance to the right again.

Further, data pages to be hologram-recorded have inserted therein modulated data and positioning markers LM to detect data positions with. For example, as shown in FIG. 4, positioning markers LM are placed in the four corners of the data page with the other area being a data area DR.

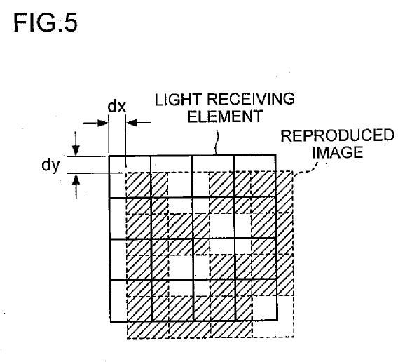

The reproduced signal from the hologram memory is substantially the same two-dimensional signal as the record signal except that the signal-to-noise ratio (SNR) is degraded, and is detected with a two-dimensional array sensor such as a CCD. At this time, minute deviation called pixel deviation may occur between pixels of the reproduced signal and pixels of the two-dimensional sensor. For example, if a minute pixel deviation (dx, dy) exists as shown in FIG. 5, the detected signal of the two-dimensional sensor is degraded because it is subjected to interference from adjacent pixels, which affects the determination of “bright (1)”/“dark (0)”.

The sensor output when a pixel deviation exists is as follows. Because the sensor output is thought to be proportional to the area of part of the reproduced signal incident on the sensor, letting dx, dy be pixel deviation amounts in a horizontal direction (x-direction) and in a vertical direction (y-direction), the transfer function H of the pixel deviation is expressed as:

$$H = [ \begin{matrix}( 1 - dx ) ( 1 - dy ) & dx ( 1 - dy ) \\ ( 1 - dx ) dy & dxdy\end{matrix} ] \qquad [ Expression 1 ]$$

Here, let P be the reproduced signal, then the sensor output R can be expressed as R=P*H, where “*” represents a convolution operation.

By performing maximum likelihood (ML) decoding with the above transfer function H as a partial response (PR) characteristic, accurate decoding is possible even if the reproduced signal is degraded due to interference from adjacent pixels.

In this embodiment, the case where Viterbi decoding is used as the maximum likelihood (ML) decoding will be described. The BCJR algorithm may be used as the maximum likelihood decoding. Note that the above positioning markers LM are used also when detecting the pixel deviation. The pixel deviation can be detected according to the method described in, e.g., Japanese Patent Application No. 2005-059464.

### <Two-Dimensional Demodulation>

Next, the process of reproducing a recorded data page will be described for the case where the 6:9 modulation, an example of two-dimensional modulation, has been performed thereon.

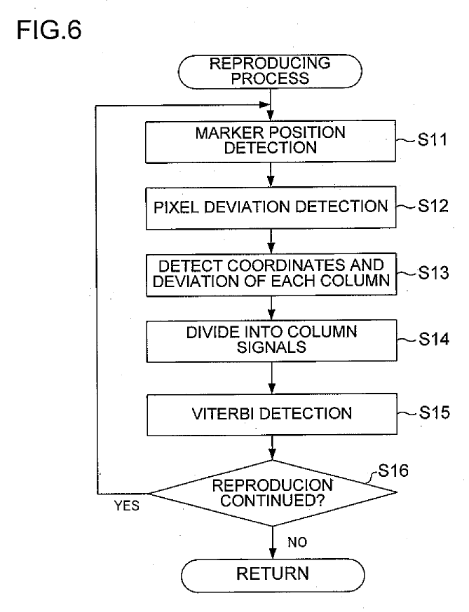

FIG. 6 shows a flow chart of the process flow of reproducing a data page in a demodulation apparatus using decision feedback Viterbi detection.

The reference light 12 is irradiated onto the recording medium 10 having a data page recorded, and the reproduced light from the recording medium 10 is received by the image sensor 20 to obtain a data page signal. (Reproducing Process)

In this data reproduction, first the positions (coordinates) of positioning marks are detected from the data page signal (step S11). For example, the positions of the above positioning markers LM placed in the four corners are detected.

In detecting the positions of positioning marks, for each given part of the data page signal, a correlation between the template of a known positioning mark and the given part of the data page signal is computed, and the position of a given part for which the correlation value is a maximum can be taken as the position of the positioning mark. This position detection result is coordinates in pixel units (integer coordinates).

Next, the pixel deviation dx, dy between reproduction pixels and light receiving elements as shown in FIG. 5 is detected (step S12). The pixel deviation dx, dy can be detected from the maximum correlation value and its neighboring correlation values calculated at step S11 by, e.g., centroid computation. This pixel deviation is a relative position deviation from the integer coordinates detected at step S11 and hence is expressed as decimal fraction coordinates. A start point, end point, and decision feedback direction of Viterbi detection are determined from the integer coordinates and decimal fraction coordinates calculated at steps S1, S2.

Or, the pixel deviation amounts of positioning marks may be obtained using a template matching technique as shown in, for example, Japanese Patent Application Laid-Open Publications No. H05-120436, No. H10-124666, and No. 2001-195597.

Then, the coordinates and pixel deviation of each column of modulation symbols are calculated from the coordinates and pixel deviation of four markers LM (step S13).

Then, the signal is divided into column signals according to the calculated coordinates of each column (step S14). Namely, the output signal of the image sensor denoting a reproduced image is divided into blocks according to the two-dimensional modulation symbols of the 6:9 modulation and further divided into matrix data symbols each consisting of 9 pixels (bits) in 3 rows and 3 columns.

Next, Viterbi detection (decoding) is performed (step S15). More specifically, Viterbi detection is performed for each column of modulation symbols.

Namely, where Viterbi detection is performed on per symbol basis, if the number of bits that the modulation symbol represents is small as with 1:2 modulation, 2:4 modulation, or the like, a problem hardly occurs, but if the number of bits that the modulation symbol represents is large as with 6:9 modulation, 8:12 modulation, or the like, the computation amount (or scale of the computing circuit) increases exponentially, and thus Viterbi detection becomes difficult. Accordingly, in the present embodiment, in order to reduce the computation amount (or scale of the computing circuit), Viterbi detection is performed on each of the columns of the modulation symbol.

After Viterbi detection is completed, it is determined whether to continue the reproducing process. If the reproducing process is to be continued, the procedure of step S11 and later is repeated. If the reproducing process is to end, the process goes outside this routine (step S16).

### <Metric Computation>

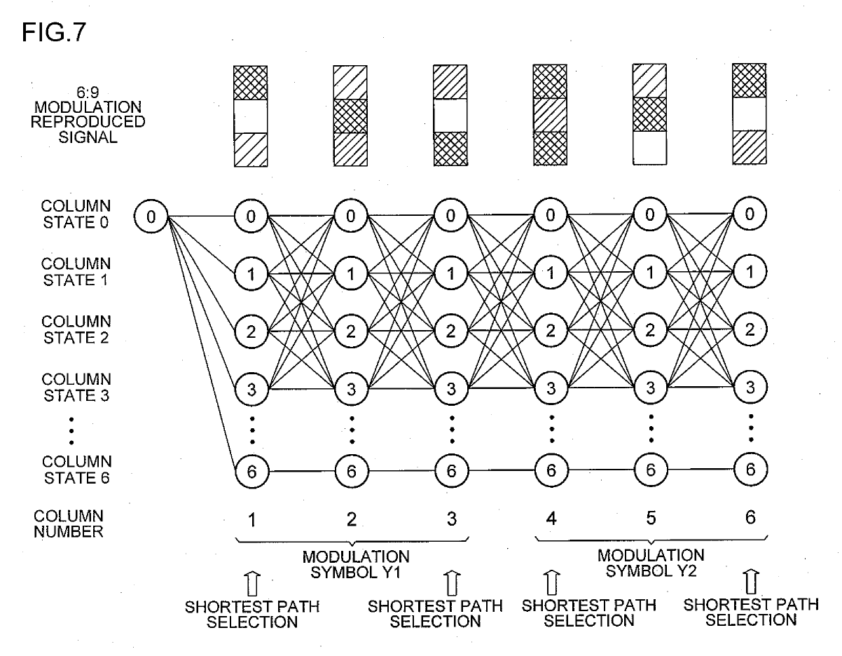

FIG. 7 shows a trellis diagram for when Viterbi detection is performed on each of the columns of the modulation symbol. As mentioned previously, because the modulation rule that leaves out the patterns where three “bright (1)” pixels are arranged consecutively in line is adopted, the state of the column ranges from “state 0” to “state 6” of seven states (the state value=0 to 6).

In FIG. 7, column numbers 1 to 3 indicate the first to third columns of a first modulation symbol Y1, and column numbers 4 to 6 indicate the first to third columns of the next modulation symbol, that is, a modulation symbol Y2 subsequent to the modulation symbol Y1.

As such, where Viterbi detection is performed on a per column basis, the computation amount is reduced as compared with where Viterbi detection is performed on a per modulation symbol basis. However, there is a possibility that the detection result may not be compliant with the modulation rule. For example, a path not compliant with the modulation rule shown in FIG. 3 may be left. To be more specific, a set of column states (column-1 state to column-3 state) that does not exist in the modulation rule shown in FIG. 3 is left such as a column state value set (2, 2, 2), which means that the state values of column-1 to column-3 are at 2.

This is because, while the number of all path combinations from column-1 to column-3 in the trellis diagram is at 7×7×7=343, the number of all path combinations compliant with the modulation rule is at merely 64 as shown in FIG. 3. That is, when Viterbi detection is performed on a per column basis, a path not compliant with the modulation rule may be selected, which is caused by the algorithm selecting the shortest path for each column state for each column.

Accordingly, in order to exclude paths not compliant with the modulation rule, the shortest path selection is performed only at the column of each modulation symbol at which the modulation symbol is determined, that is, the last column (“column-3”, that is, the third column, sixth column, ninth column, . . . of the input data series), and at the symbol start column (“column-1”, that is, the first column, fourth column, seventh column, . . . of the input data series) as shown in FIG. 7. Further, path metric computation and storage are performed on a per modulation symbol basis. Hereinafter, the numbers of the first column, second column, third column, fourth column, . . . of the input data series that is a data sequence of modulation symbols inputted consecutively are also called column numbers. That is, in the case of the 6:9 modulation, column numbers 1, 4, 7, . . . of the input data series are the column numbers of symbol start columns, and column numbers 3, 6, 9, . . . are those of symbol last columns.

In the present embodiment, description will be made taking as an example the case of using the 6:9 modulation, where the two-dimensional modulation symbol consists of 9 pixels (bits) in 3 rows and 3 columns. Hence, the start column and the last column of the modulation symbol are also called “column-1” and “column-3” respectively.

However, not being limited to this, other modulation schemes different in the size of the two-dimensional modulation symbol may be used. For example, in the case of 8:12 modulation which converts 8-bit input data into a modulation symbol consisting of 12 pixels (bits) in 3 rows and 4 columns, the symbol start column is the first column (“column-1”) of each modulation symbol, and the symbol last column is the fourth column (“column-4”) of each modulation symbol. In this case, since the number of modulation symbol patterns is at 256 (=28), with the symbol state value k=0 to 255, the present invention can be applied thereto as is to the 6:9 modulation.

For ease of description, in the description below, a path metric (PM) calculated for each modulation symbol is called a symbol path metric (SPM), and a path metric calculated for each column state is called a column path metric (CPM).

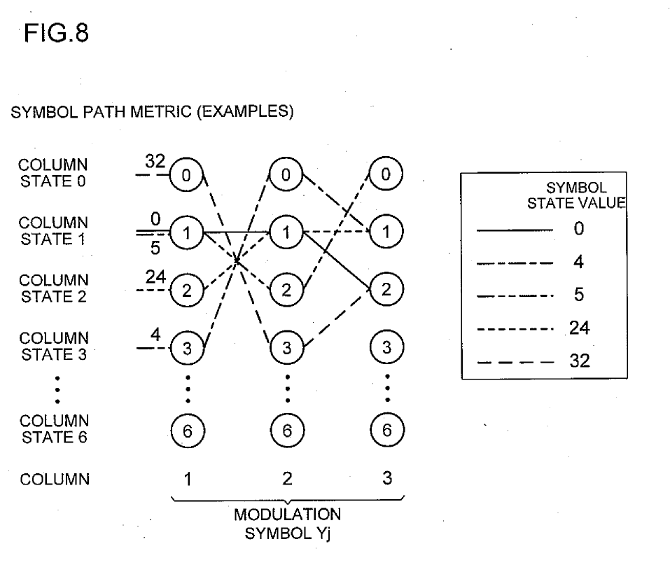

The symbol path metric (SPM) is obtained for each symbol state value of FIG. 3 by adding branch metrics (BMs) of column-1 to column-3 to the preceding column path metric (CPM). For example, each line shown in FIG. 8 corresponds to an SPM. Although only five SPMs (symbol state value k=0, 4, 5, 24, 32) are shown as examples in FIG. 8, in reality there are 64 SPMS.

### <Viterbi Detection Circuit>

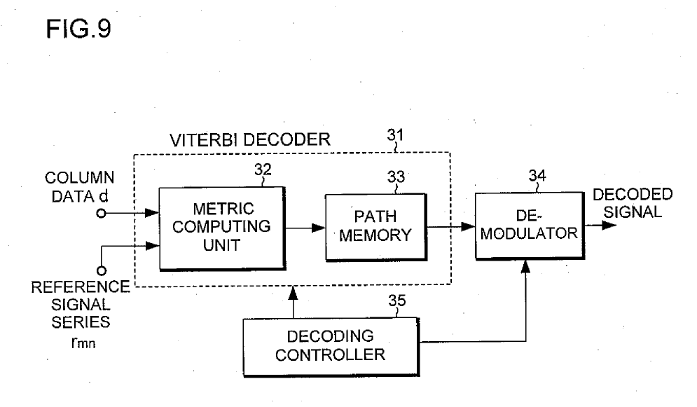

FIG. 9 is a block diagram showing the configuration of a decoding circuit used in decoding the reproduced signal from a hologram memory. The decoding circuit comprises a Viterbi detector (decoder) 31 comprising a metric computing unit 32 and a path memory 33; a demodulating circuit 34; and a decoding controller 35. The Viterbi detector 31 and the demodulating circuit 34 operate under the control of the decoding controller 35. The path memory 33 has a circuit configuration as shown in, for example, Japanese Patent Application Laid-Open Publication No. H05-136700.

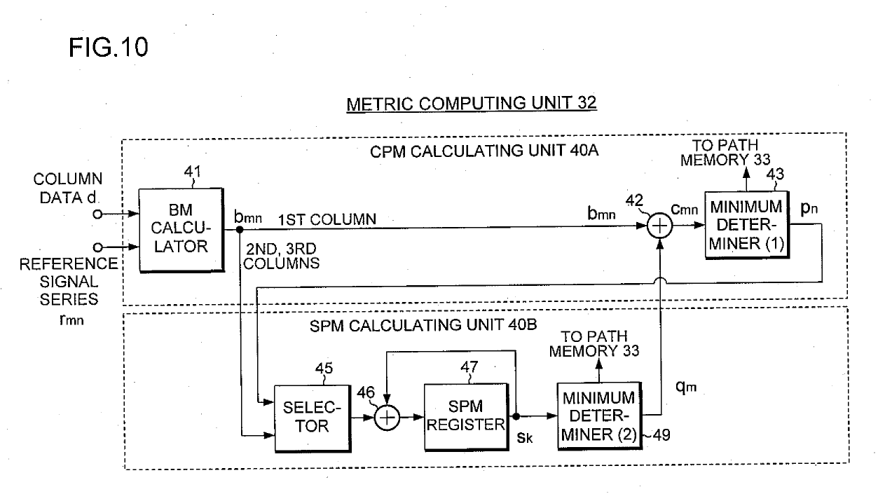

FIG. 10 is a block diagram showing an example of the internal configuration of the metric computing unit 32. The metric computing unit 32 comprises a CPM calculating unit 40A and an SPM calculating unit 408.

In the figure, bmn denotes branch metrics (BMs) calculated for each column from an input data series d and a reference signal series rmn. pn and qm denote column path metrics, and sk denotes symbol path metrics (SPMs), where the suffix m indicates the preceding column state value and the suffix n indicates the current column state value, and each of them takes on a value of 0 to 6. The initial value of the qm is set at 0.

The reference signal series rmn inputted to the metric computing unit 32 can be calculated beforehand as below. For example, the controller 23 calculates the reference signal series rmn from reproduced data. The calculated reference signal series rmn is stored in a storage device such as a RAM (Random Access Memory) (as a reference signal conversion table).

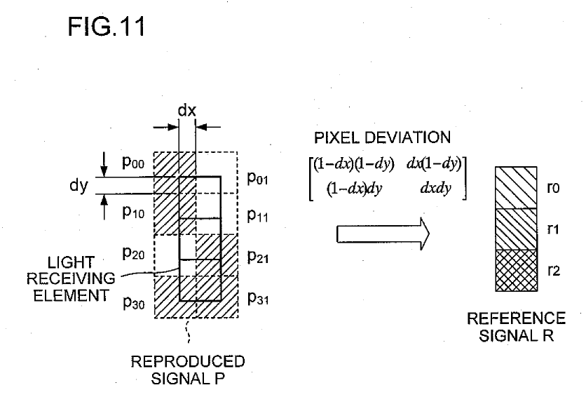

As to the reference signal series rmn, when the reproduced signal P is expressed as the matrix below as shown in FIG. 11, the sensor output R (the reference signal) for a column of the modulation symbol can be expressed as R=P*H.

$$P = [ \begin{matrix}{p}_{00} & {p}_{01} \\ {p}_{10} & {p}_{11} \\ {p}_{20} & {p}_{21} \\ {p}_{30} & {p}_{31}\end{matrix} ] \qquad [ Expression 2 ]$$

Here, H is a transfer function of the pixel deviation expressed as below, and * represents a convolution operation.

$${b}_{mn} = {\sum }_{i = 0}^{2} {( {d}_{i} - {r}_{mni} )}^{2} \qquad [ Expression 3 ]$$

The transfer function H of the pixel deviation is defined by a pixel deviation dx in a row direction (horizontal direction) and a pixel deviation dy in a column direction (vertical direction). To be more specific, as shown in FIG. 11, the reference signal can be calculated from combinations of dx, dy, and eight pixels (p00, p01, p10, p11, p20, p21, p30, p31). The values calculated from all such combinations are stored as the reference signal in the memory.

Let dx and dy be, e.g., decimal fractions of −0.9 to +0.9, which vary by 0.1. Of the eight pixels, p00 and p01 are thought to be a Viterbi detection result for the row immediately above, and (p10, p20, p30) and (p11, p21, p31) are each thought to be a column.

When performing Viterbi detection, the pixel deviation (dx, dy) and the detection result (p00, p01) from the row immediately above are already determined, and hence branch metrics can be calculated from the input data series d and the reference signal series rmn for combinations with the two columns (p10, p11, p20, p21, p30, p31).

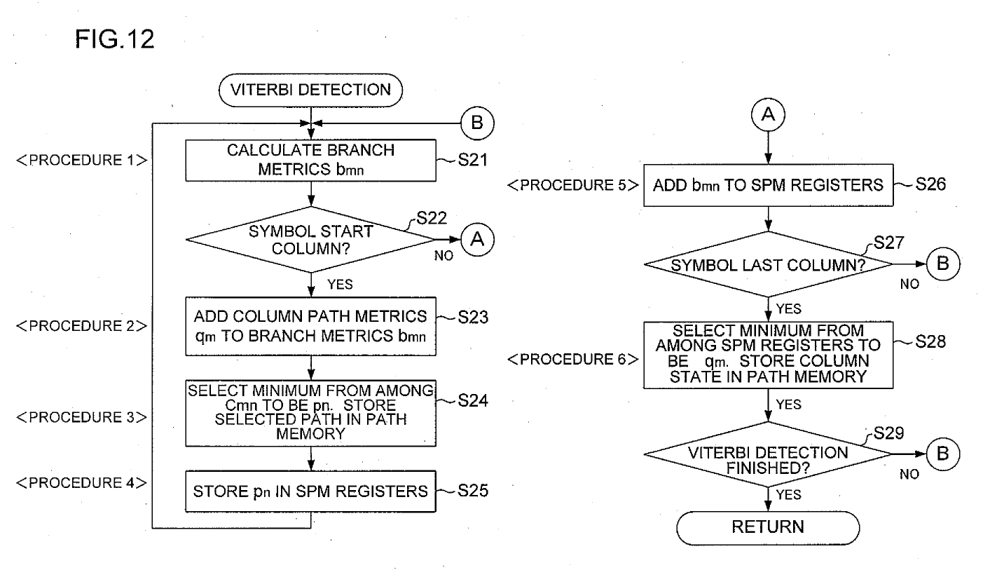

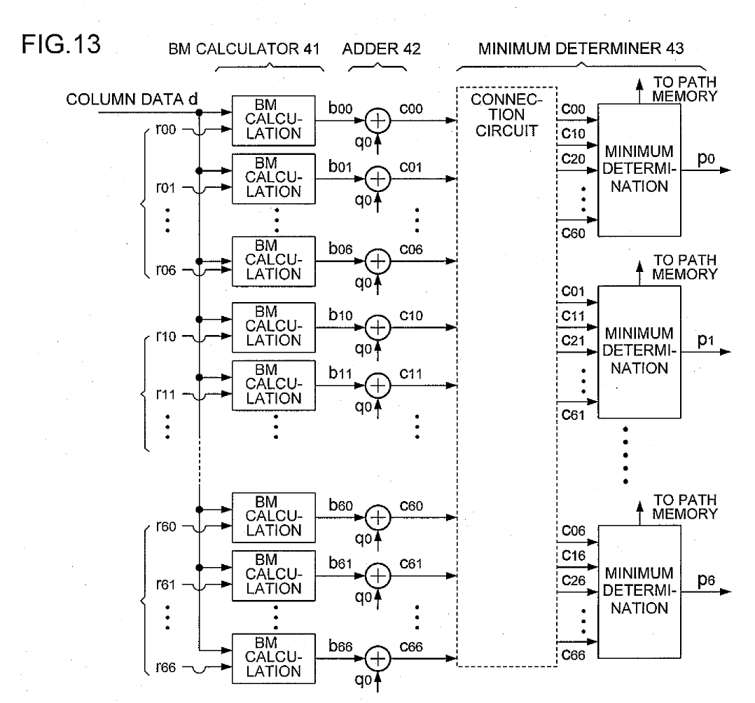

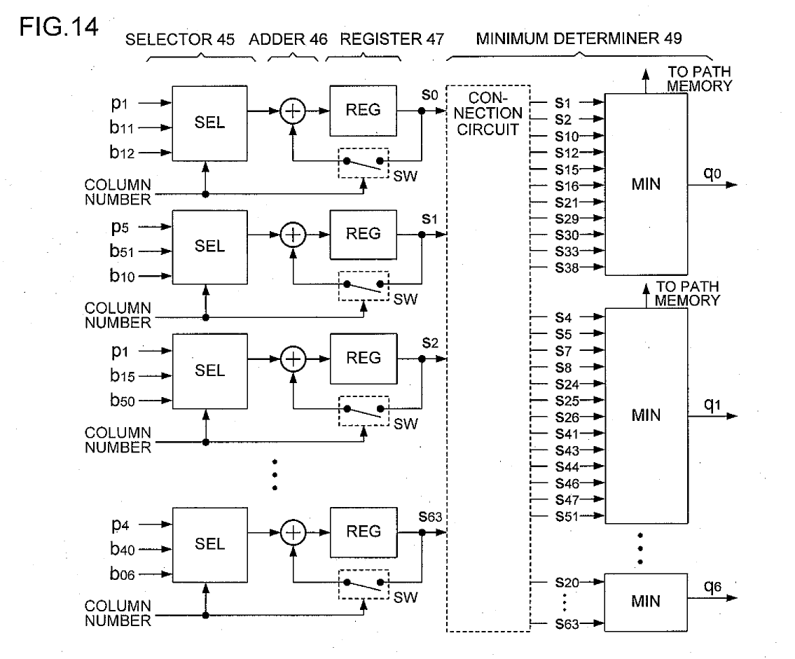

FIG. 12 is a flow chart showing the procedure of Viterbi detection when decoding the reproduced signal. FIGS. 13 and 14 are circuit diagrams showing schematically examples of the specific circuit configurations of the CPM calculating unit 40A and the SPM calculating unit 40B respectively. Hereinafter, description will be made taking the case of using the 6:9 modulation as an example.

### [Procedure 1]

In the Viterbi detection of the reproduced signal modulated when recording, a branch metric calculator (BM calculator) 41 (FIGS. 10, 13) calculates branch metrics bmn for each column of a modulation symbol from the input data series d and the reference signal series rmn (step S21). As mentioned above, pn and qm denote column path metrics, and sk denotes symbol path metrics, where the suffix m indicates the preceding column state value and the suffix n indicates the current column state value, and each of them takes on a value of 0 to 6. The initial value of the qm is at 0. The k is a symbol state value which takes on a value of 0 to 63.

Here, the input data series d and the reference signal series rmn are each a matrix with three rows and one column. Let di, rmni (i=0, 1, 2) be their elements respectively. Then bmn is expressed as:

$${b}_{mn} = {\sum }_{i = 0}^{2} {( {d}_{i} - {r}_{mni} )}^{2} \qquad [ Expression 4 ]$$

Next, it is determined whether the current column is a symbol start column (“column-1”) (step S22). If the current column is a symbol start column (“column-1”), the process proceeds to the next step S23 (procedure 2). If not, the process proceeds to step S26 (procedure 5) described later.

### [Procedure 2]

An adder 42 adds the calculated branch metrics bmn and the column path metrics qm from the SPM calculating unit 40B to obtain cmn. Note that bmn and qm are added together for each common value of m (see FIG. 13) (step S23). The initial value of the qm is at 0 as mentioned above. Then the process proceeds to procedure 3.

### [Procedure 3]

For each value of the current column state value n (n=0, 1, . . . , 6), the minimum is determined (selected) from the obtained cmn, where m=0 to 6, to be the column path metric pn. Then the selected path is stored in the path memory 33.

Description will be made with reference to FIG. 13. If, for example:

the minimum from among c00 to c60 is c30, the minimum from among c01 to c61 is c61, the minimum from among c06 to c66 is c46, then a first minimum determiner (minimum determiner (1)) 43 sets these minimums as pn (n=0, 1, . . . , 6), namely p0=c30, p1=c61, . . . , p6=c46, and determines the selected paths for n=0, 1, . . . , 6 to be 3, 6, . . . , 4. The selected paths, that is, the shortest paths are stored in the path memory 33 (step S24). Then the process proceeds to procedure 4.

### [Procedure 4]

The pn (n=0, 1, . . . , 6) obtained in procedure 3 are stored in an SPM register unit 47. More specifically, the SPM register unit 47 comprises 64 SPM registers sk corresponding to the modulation symbol patterns (FIG. 3), where k is the symbol state value, k=0, 1, . . . , 63. Note that since the SPM registers sk store symbol path metrics, the stored symbol path metrics (computed values) are indicated by the same reference symbols sk for ease of illustration.

The pn (n=0, 1, . . . , 6) is stored in SPM registers sk corresponding to the modulation symbols (symbol state values) the state value of whose symbol start column is n (=0, 1, . . . , 6). This will be described more specifically below.

SPM registers corresponding to the modulation symbols the column state value of whose symbol start column (“column-1”) is “0” (i.e., the current column state value n=0) are set equal to the column path metric p0. Since the symbol state values k of the modulation symbols whose column-1 state value is “0” are 26, 27, 32, 34, 36, 37, 40, 47, 48, 50, and 53 (see FIG. 3), the SPM registers s26, s27, s32, s34, s36, s37, s40, s47, s48, s50, and s53 corresponding to those modulation symbols (symbol state values) are set to the column path metric p0.

The SPM registers s0, s2, s3, s5, s6, s8, s9, s14, s16, s17, s19, s20, and s23 which correspond to the modulation symbols the column state value of whose symbol start column (“column-1”) is “1” (n=1) are set to the column path metric p1.

Likewise, the SPM registers corresponding to the modulation symbols the column state value of whose symbol start column is from “2” to “6” are set to the column path metrics p2 to p6 respectively (step S25). Then the process returns to procedure 1.

### [Procedure 5]

The branch metric bmn is added to the SPM registers corresponding to modulation symbols of which the preceding column state value is m and the current column state value is n.

For example, when the current column is the second column, b01 is added to the SPM registers s27, s37 corresponding to modulation symbols of which the column-1 state value is 0 and the column-2 state value is 1 (see FIG. 3).

When the current column is the third column, b12 is added to the SPM registers s0, s28, s35 corresponding to modulation symbols of which the column-2 state value is 1 and the column-3 state value is 2.

Likewise, the other branch metrics bmn are added to the corresponding SPM registers (step S26).

Next, it is determined whether the current column is the symbol last column (“column-3”) (step S27). If the current column is the symbol last column, the process proceeds to the next step S28 (procedure 6). If not, the process returns to the above step S21 (procedure 1).

### [Procedure 6]

From among the SPM registers corresponding to the modulation symbols whose symbol last columns are of the same state value, the minimum is determined to be the column path metric qm. Further, the column state values of the start column to the column preceding the last column of the modulation symbol corresponding to the selected (determined) SPM register (i.e., the shortest path) are stored in the path memory 33.

For example, if the minimum from among the values stored in the SPM registers s1, s2, s10, s12, s15, s16, s21, s29, s30, s33, and s38 corresponding to the modulation symbols whose symbol last column state values are 0 (the column-3 state values=0) is s15, then q0 is set equal to s15, and the column state values, here 5 and 2, of the start column to the column preceding the last column of the modulation symbol corresponding to s15 (i.e., the column-1 and column-2 state values of the symbol state value 15) are stored as the shortest path (remaining path) in the path memory 33 (step S28).

For q1 to q6, the same process is performed.

Then, it is determined whether the Viterbi detection is completed (step S29). If completed, the process in this routine ends, and if the Viterbi detection is to be continued, the process returns to the procedure 1 (step S21) to repeat the above procedures.

The calculation of the symbol path metrics (s0 to s63) that are stored in the SPM registers (s0 to s63) will be described more specifically and in detail below.

As shown in FIG. 14, a selector 45 switches inputs according to the column number of the input modulation symbol. As mentioned previously, the SPM calculating unit 40B that comprises the selector 45, an adder 46, the SPM register 47, and a second minimum determiner (minimum determiner (2)) 49 operates under the control of the decoding controller 35.

As described with respect to the above procedures 1 to 6 (FIG. 12), the symbol path metrics s0 to s63 are calculated by calculating the column path metrics pn of the start column at the start column of the modulation symbol, performing branch metric computation for each column of the modulation symbol, and adding the column path metrics pn and the branch metrics between each column and the next.

First, description will be made taking the calculating and storing of the symbol path metric so as an example. When the column number of the input modulation symbol indicates a symbol start column, namely, when the column number is one of 1, 4, 7, since the column-1 state value of the symbol state value (k=0) is “1” (n=1) (see FIG. 3), the selector 45 selects the column path metric pn=p1. Note that as described with respect to the above procedures 1 to 3 (steps S21 to S24), the column path metric pn is a minimum determined from among cm1 (m=0 to 6) corresponding to the state value n (=1) at this start column. Then, the p1 is stored in the register so, as it is, with no addition to p1 by the adder 46 (SW being off).

When the column number indicates not a symbol start column nor the last column (but a column between a start column and the last column), namely, when the column number is one of 2, 5, 8, . . . (“column-2”), the selector 45 selects the branch metric b11. That is, since the symbol state value (k) is 0, the column state value (m) of the preceding column (start column) is the column-1 state value of “1”, and the column state value (n) of the current column (“column-2”) is the column-2 state value of “1”, and hence b11 is selected as the branch metric bmn. The selected branch metric b11 is added to the symbol path metric so (SW being on), and the resultant is stored in the register so.

When the column number indicates the last column, namely, when the column number is one of 3, 6, 9, (“column-3”), the selector 45 selects the branch metric b12. That is, since the column state value (m) of the preceding column is the column-2 state value of “1” and the column state value (n) of the current column is the column-3 state value of “2”, b12 is selected as the branch metric bmn. The selected branch metric b12 is added to the symbol path metric so, and the resultant is stored in the register s0.

Likewise, calculation is performed for the symbol path metrics s1 to s63, and the resultant values are stored in the registers. The symbol path metrics s0 to s63 calculated in this way are divided into groups according to the column state at the symbol last column (i.e., the column-3 state value) via a connection circuit, and the minimum determiner 49 determines the minimum from each of the groups. More specifically, the minimum determiner 49 determines the minimum from among the symbol path metrics s1, s2, s10, s12, s15, s16, s21, s29, s30, s33, and s38 whose column-3 state values are 0 (see, FIG. 3). That minimum is supplied to the path memory 33 and supplied as the column path metric q0 to the CPM calculating unit 40A.

For example, if that minimum is s15, q0 is set equal to s15, and the column state values, here 5 and 2, of the start column to the column preceding the last column of the modulation symbol corresponding to s15 (i.e., the column-1 and column-2 state values of the symbol state value 15) are stored in the path memory 33 (step S28).

Likewise, determination is performed for the column path metrics q1 to q6 as well, and the resultant values are supplied to the path memory 33 and the CPM calculating unit 40A.

The contents of the path memory 33 obtained by the above procedures indicate transitions between column states shown in FIG. 3, and hence by decoding these, data demodulation is executed.

As described above, on the sequence of modulation symbols modulated according to the predetermined modulation rule and each having M rows and N columns, the maximum likelihood decoding is performed by performing sequential metric computation on each of the modulation symbols. This maximum likelihood decoding is performed as follows.

At only the start column and the last column of each modulation symbol, the shortest path is selected. At the start column of the modulation symbol, the column path metrics of the start column are calculated, and the shortest path is selected for each of the column state values.

Further, branch metrics are computed for each column of the modulation symbol.

Then, the symbol path metrics of the modulation symbols for the state transitions (the symbol state values k) compliant with the modulation rule shown in FIG. 3 are calculated based on the column path metrics of the start column of the modulation symbol and the branch metrics of the column next to the start column up to the last column of the modulation symbol.

To be more specific, in order to store the symbol path metrics, there is provided a computed value table (path metric registers) that stores a computed value (path metric) for each of the symbol state values of the modulation symbols.

At the start column of each modulation symbol, a column path metric for each of the column state values of the start column is calculated and stored at a corresponding position in the computed value table (symbol path metric registers sk). Branch metrics calculated by the branch metric computation at the column next to the start column up to the last column of the modulation symbol are added to the value at the corresponding position in the computed value table. By this means, the symbol path metrics of the modulation symbols are calculated for the respective symbol state values (k) and stored in the computed value table.

At the start column of each modulation symbol, the shortest path is selected for each of the column state values of the start column. To be specific, from among the values obtained by adding the column path metrics of the last column of the modulation symbol preceding the current modulation symbol respectively to the values calculated by the branch metric computation at the start column of the current modulation symbol, a minimum is determined for each of the column state values of the start column, and the shortest path is selected.

Moreover, the shortest path is selected at the last column of the modulation symbol. To be specific, for each of the column state values of the last column (i.e., for each group of the symbol last columns of the same column state value), a minimum is determined from among symbol path metrics, and the shortest path at the last column is selected.

### <Decoding Results>

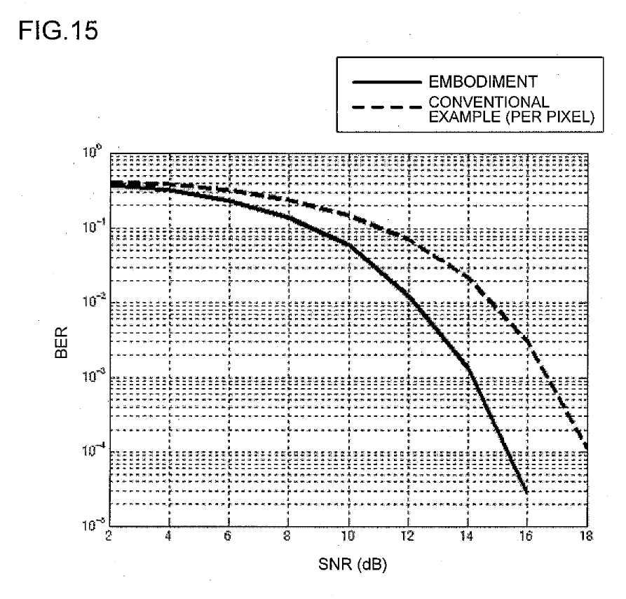

FIG. 15 shows a bit error rate (BER) characteristic in a case where the Viterbi detection according to the above embodiment was performed for decoding in comparison with a bit error rate characteristic in a case of performing Viterbi detection on the reproduced signal from the hologram memory on a per pixel (bit) basis.

The bit error rate characteristic in the above case where decoding according to the embodiment was performed is greatly improved as compared with that of the case of performing Viterbi detection on a per pixel (bit) basis.

This is because, in the case of performing Viterbi detection on a per pixel (bit) basis, Viterbi detection is performed irrespective of the modulation rule and thus the detection results may not be compliant with the modulation rule with an increase in the error rate, although with m and n being 0 or 1 (two states), the circuit scale can be reduced.

On the other hand, in the case of performing Viterbi detection on a per modulation symbol basis, the detection results are compliant with the modulation rule, and hence its error rate characteristic does not differ from that of the case of performing decoding according to the embodiment. However, in the case of the 6:9 modulation, with m and n=0 to 63 (64 states), the metric computation amount or the circuit scale greatly increase.

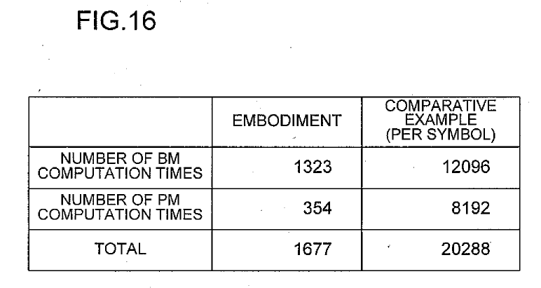

FIG. 16 shows the computation amount (number of computation times) in a case where the decoding according to the present embodiment was performed in comparison with that of a case of performing Viterbi detection on a per modulation symbol basis. In the case where the decoding according to the present embodiment was performed, the computation amount is reduced to about 1/12 of that of the case of performing Viterbi detection on a per modulation symbol basis.

Therefore, according to the present embodiment, the computation amount (or the circuit scale) is reduced, and a good error rate characteristic can be obtained.

While in the above embodiment description has been made taking the 6:9 modulation as an example, the present invention can be applied to other two-dimensional modulations.

Moreover, the present invention can be applied even to one-dimensional modulation if it is fixed-length modulation and the modulation rule is longer than the constraint length of maximum likelihood decoding.

1. A demodulation method which reads modulation symbols sequentially from a recording medium in which a data page that is a group of a plurality of data symbols modulated according to a predetermined modulation rule and each having M rows and N columns (M≧1, N≧3) is recorded and reproduces said data page by maximum likelihood decoding which performs sequential metric computation on each of said modulation symbols, comprising the steps of:
performing branch metric computation on each of columns of said modulation symbol;
calculating column path metrics that are respective path metrics of column state values of said modulation symbols; and
calculating symbol path metrics that are respective path metrics of symbol state values of said modulation symbols.

2. A demodulation method according to claim 1, comprising the step of. at a start column of said modulation symbol, calculating column path metrics of said start column and selecting the shortest path for each of the column state values of said start column,
wherein said step of calculating symbol path metrics, calculates a corresponding one of said symbol path metrics for each of the symbol state values compliant with said modulation rule.

3. A demodulation method according to claim 2, wherein symbol path metrics of said modulation symbols are calculated based on said column path metrics of said start column and branch metrics between each said column and the next.

4. A demodulation method according to claim 2, further comprising a step of:
selecting a shortest path by determining a minimum for each of the column state values at the last column of said modulation symbol from among symbol path metrics for the column state value at the last column.

5. A demodulation method according to claim 2, wherein said step of selecting the shortest path for each of the column state values of a start column, determines a minimum for each of the column state values of said start column from among sums obtained by adding column path metrics of a preceding modulation symbol respectively to values calculated by said branch metric computation, thereby selecting the shortest path.

6. A demodulation method according to claim 1, comprising the steps of:
providing a computed value table for storing a computed value for each of symbol state values of said modulation symbols;
calculating at a start column of said modulation symbol a column path metric for each of the column state values of said start column and storing said column path metric at corresponding positions of said computed value table; and
adding each of branch metrics calculated in said step of performing branch metric computation to values at corresponding positions of said computed value table.

7. A demodulation method according to claim 1, wherein said modulation rule is longer than a constraint length in said maximum likelihood decoding, and said modulation symbols each have one row and N columns (N≧3).

8. A demodulation method according to claim 1, wherein said maximum likelihood decoding is decision feedback Viterbi detection.

9. A demodulation apparatus which reads modulation symbols sequentially from a recording medium in which a data page that is a group of a plurality of data symbols modulated according to a predetermined modulation rule and each having M rows and N columns (M≧1, N≧3) is recorded and reproduces said data page by maximum likelihood decoding which performs sequential metric computation on each of said modulation symbols, said apparatus comprising:
a branch metric computing unit for performing branch metric computation on each of columns of said modulation symbol;
a column path metric computing unit for calculating column path metrics that are respective path metrics of column state values of said modulation symbols; and
a symbol path metric computing unit for calculating symbol path metrics that are respective path metrics of symbol state values of said modulation symbols.

10. A demodulation apparatus according to claim 9, wherein said branch metric computing unit, at a start column of said modulation symbol, calculates column path metrics of said start column and selects the shortest path for each of the column state values of said start column, and said symbol path metric computing unit calculates a corresponding one of said symbol path metrics for each of the symbol state values compliant with said modulation rule.

11. A demodulation apparatus according to claim 10, wherein said symbol path metric computing unit calculates symbol path metrics of said modulation symbols for each of the column state values based on said column path metrics of said start column and branch metrics between each said column and the next.

12. A demodulation apparatus according to claim 10, comprising a minimum determining unit for determining a minimum for each of the column state values at the last column of said modulation symbol from among symbol path metrics for the column state value at the last column, thereby selecting the shortest path.

13. A demodulation apparatus according to claim 10, comprising:
a computed value table for storing a computed value for each of symbol state values of said modulation symbols,
wherein said symbol path metric computing unit stores a column path metric for each of the column state values of said start column, which metric has been calculated in said column path metric computing unit, at corresponding positions of said computed value table, and adds each of branch metrics calculated in said branch metric computing unit to values at corresponding positions of said computed value table.
